(19) United States
(12) Patent Application Publication
(10) Pub. No.: US 2022/0207860 A1
(43) Pub. Date: Jun. 30, 2022

(54) SIMILAR AREA DETECTION DEVICE, SIMILAR AREA DETECTION METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi (JP)

(72) Inventor: Ryou KIYAMA, Chigasaki (JP)

(73) Assignees: KABUSHIKI KAISHA TOSHIBA, Tokyo (JP); TOSHIBA DIGITAL SOLUTIONS CORPORATION, Kawasaki-shi (JP)

(21) Appl. No.: 17/655,635

(22) Filed: Mar. 21, 2022

Related U.S. Application Data
(63) Continuation of application No. PCT/JP2020/035285, filed on Sep. 17, 2020.

(30) Foreign Application Priority Data
Sep. 25, 2019 (JP) 2019-174422

(51) Int. Cl. G06V 10/75; G06V 10/40; G06T 7/13; G06V 10/74

(52) U.S. Cl. CPC G06V 10/757; G06V 10/761; G06T 7/13; G06V 10/40

(57) ABSTRACT

A similar area detection device according to an embodiment includes an acquisition unit, a feature-point-extraction unit, a matching unit, an outermost contour extraction unit, and a detection unit. The acquisition unit acquires a first image and a second image. The feature-point-extraction unit extracts feature points from each of the first image and the second image. The matching unit associates the feature points extracted from the first image with the feature points extracted from the second image, and detects corresponding points between images. The outermost contour extraction unit extracts an outermost contour from each of the first image and the second image. The detection unit detects a similar area from each of the first image and the second image based on the outermost contours and the number of corresponding points. Similar areas are partial areas similar to each other between the first and the second images.

### CROSS-REFERENCE TO RELATED APPLICATIONS

This application is a continuation of PCT International Application No. PCT/JP2020/035285 filed on Sep. 17, 2020 which claims the benefit of priority from Japanese Patent Application No. 2019-174422, filed on Sep. 25, 2019, the entire contents of which are incorporated herein by reference.

### FIELD

Embodiments described herein relate generally to a similar area detection device, a similar area detection method, and a computer program product.

### BACKGROUND

As a methodology for determining a similarity between images, template matching is widely known. Template matching is a technique that compares a template image with a comparison-target image to detect a part similar to the template image from the comparison-target image. However, while template matching is capable of detecting an area similar to the whole template image from the comparison-target image, the template matching is not capable of detecting an area similar to a partial area of the template image.

### BRIEF DESCRIPTION OF THE DRAWINGS

FIG. 1 is a block diagram illustrating a functional configuration example of a similar area detection device according to an embodiment;

FIG. 2 is a flowchart illustrating an example of a processing sequence of the similar area detection device according to the present embodiment;

FIG. 3 is a diagram illustrating specific examples of a first image and a second image;

FIG. 4 is a diagram illustrating examples of corresponding points;

FIG. 5 is a diagram illustrating examples of an outermost contour;

FIG. 6 is a diagram illustrating an example of a method for determining whether a corresponding point is inside the outermost contour;

FIG. 7 is a diagram illustrating an example of relations between the outermost contours and corresponding points;

FIG. 8 is a diagram illustrating an example of a similar image pair;

FIG. 9 is a diagram illustrating an example of a similar image pair;

FIG. 10 is a diagram illustrating an example of a similar image pair;

FIG. 11 is a diagram for describing an example of a method for checking positional relations of the corresponding points;

FIG. 12 is a diagram for describing another example of feature point matching;

FIG. 13 is a diagram illustrating examples of a similar image pair; and

FIG. 14 is a block diagram illustrating a hardware configuration example of the similar area detection device according to embodiments.

### DETAILED DESCRIPTION

A similar area detection device according to an embodiment includes one or more hardware processors configured to function as an acquisition unit, a feature point extraction unit, a matching unit, an outermost contour extraction unit, and a detection unit. The acquisition unit acquires a first image and a second image. The feature point extraction unit extracts feature points from each of the first image and the second image. The matching unit associates the feature points extracted from the first image with the feature points extracted from the second image, and detects corresponding points between images. The outermost contour extraction unit extracts an outermost contour from each of the first image and the second image. The detection unit detects a similar area from each of the first image and the second image based on the outermost contour and the number of the corresponding points, where the similar area is a partial area similar to each other between the first image and the second image. An object of the embodiments described herein is to provide a similar area detection device, a similar area detection method, and a computer program product capable of detecting, from each image, a similar area that is a partial area similar to each other between the images.

Hereinafter, a similar area detection device, a similar area detection method, and a computer program thereof according to embodiments will be described in detail with reference to the accompanying drawings.

### Outline of Embodiments

The similar area detection device according to the embodiments detects, from each of two images, a similar area that is a partial area similar to each other between the two images and, in particular, detects the similar area with a combination of feature point matching and outermost contour extraction.

Feature point matching is a technique that extracts feature points representing the features of the images from each of the two images, and associates the feature points extracted from one image with the feature points extracted from the other image based on the closeness of the local features of the respective feature points, for example. The associated feature points between the images are referred to as corresponding points. Outermost contour extraction is a technique that extracts the contour on the outermost side (outermost contour) of an object such as a figure included in an image. In the embodiments, on assumption that an object including many corresponding points in one of the images is similar to one of the objects in the other image, an area within an outermost contour including many corresponding points is detected as a similar area for each of the two images.

As a methodology for detecting similar areas, the use of feature point matching alone is also thinkable. That is, it is a method that detects an area surrounded by corresponding points acquired by feature point matching from each of two images as the similar area. However, this method has, for example, an issue of detecting only a partial area surrounded by the corresponding points within the object as the similar area instead of detecting the entire object similar between the two images; and an issue of detecting, when a corresponding point exists in a part of the object dissimilar between the two images, the area including that part of the object as the similar area. In the meantime, the embodiments employ a configuration that detects similar areas with a combination of feature point matching and outermost contour extraction, thereby enabling properly detecting the entire objects similar between the two images as the similar areas.

The similar area detection device according to the embodiments can be effectively used for automatically generating case data (learning data) for training a feature extractor to learn (supervised learning), which is used for similar image search including a partial similarity, for example. With typical similar image search, a feature indicating the feature of an image is extracted from a query and the feature of the query image is compared with the feature of a registered image to search a similar image that is similar to the query image. In the meantime, with the similar image search including partial similarity, area extraction is performed both in a query image and in a registered image, for example, and comparison of the extracted partial images is also performed. This enables even a partially similar image to be searched. As a methodology for improving the search precision of such similar image search, there is a method for training the feature extractor to learn such that the features of the images determined to be similar are made to become close to each other. This enables searching of the similar images that are unsearchable before learning.

For such similarity learning of the feature extractor, it is necessary to have a similar image pair that is a pair of two images including a certain image and a similar image similar to that image. In a case where the similar image includes a partial similarity, it is necessary to have not the entire images but the partial images that are extracted similar images of both images as a similar image pair. When acquiring such a similar image pair, there is a method with which a plurality of images is compared manually, for example, to indicate the sections determined as similar areas. With this method, however, it takes a vast amount of time to acquire a large amount of learning data. In the meantime, with the use of the similar area detection device according to the embodiments, the similar image pair between the partial images can be generated not manually but automatically and the feature extractor used for similar image search including a partial similarity can be efficiently trained.

### First Embodiment

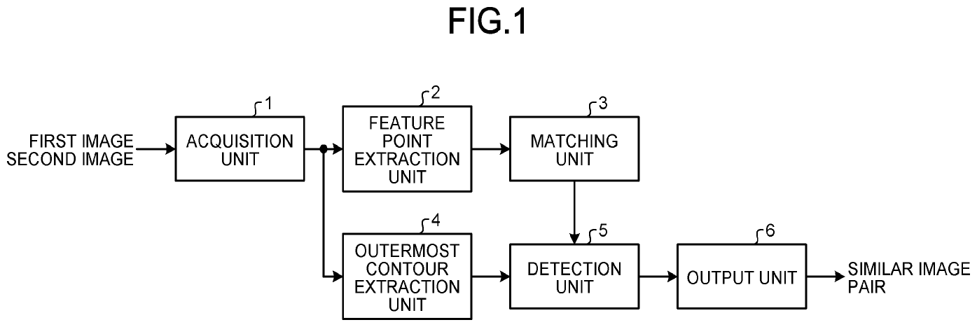

FIG. 1 is a block diagram illustrating a functional configuration example of the similar area detection device according to a first embodiment. As illustrated in FIG. 1, the similar area detection device according to the present embodiment includes an acquisition unit 1, a feature point extraction unit 2, a matching unit 3, an outermost contour extraction unit 4, a detection unit 5, and an output unit 6.

The acquisition unit 1 acquires a first image and a second image to be the target of processing from the outside of the device, and gives the acquired first image and second image to the feature point extraction unit 2, the outermost contour extraction unit 4, and the output unit 6.

The first image and the second image to be the target of processing are designated by a user who uses the similar area detection device, for example. That is, when the user designates a path indicating a stored place of the first image, the acquisition unit 1 reads out the first image saved in the path. Similarly, when the user designates a path indicating a stored place of the second image, the acquisition unit 1 reads out the second image saved in the path. Note that an image acquisition method is not limited thereto. For example, images captured by the user with a camera, a scanner, or the like may be acquired as the first image and the second image.

The feature point extraction unit 2 extracts feature points of each of the first image and the second image acquired by the acquisition unit 1, calculates local features of each of the extracted feature points, and gives information on the respective feature points and local features of the first image and the second image to the matching unit 3.

As for extraction of the feature points and calculation of the local features, a method of scale invariant and rotation invariant such as Scale-Invariant Feature Transform (SIFT), for example, may be used. Note that the method for extraction of feature points and calculation of local features is not limited thereto. For example, other methods such as Speeded-Up Robust Features (SURF), Accelerated KAZE (AKAZE), and the like may be used.

The matching unit 3 performs feature point matching for associating feature points extracted from the first image with feature points extracted from the second image based on the closeness of the local feature of each of the feature points, detects the feature points associated between the images (hereinafter, referred to as “corresponding points”), and gives the information on the corresponding points of each of the images to the detection unit 5.

For example, the matching unit 3 associates each of the feature points extracted from the first image with the feature point having the closest local feature among the feature points extracted from the second image. At this time, each of the feature points extracted from the first image, for which the feature point having the closest local feature cannot be uniquely specified among the feature points extracted from the second image, may not be associated with the feature points extracted from the second image. Furthermore, among each of the feature points extracted from the first image, the feature point whose local feature difference with respect to the feature point having the closest local feature among the feature points extracted from the second image exceeds a reference value may not be associated with the feature points extracted from the second image.

Instead of associating each of the feature points extracted from the first image with the feature point having the closest local feature among the feature points extracted from the second image, the matching unit 3 may associate each of the feature points extracted from the second image with the feature point having the closest local feature among the feature points extracted from the first image. Furthermore, the matching unit 3 may associate each of the feature points extracted from the first image with the feature point having the closest local feature among the feature points extracted from the second image and also associate each of the feature points extracted from the second image with the feature point having the closest local feature among the feature points extracted from the first image. That is, the matching unit 3 may perform bidirectional mapping. When performing such bidirectional mapping, only the feature points having the corresponding relations thereof matching in both directions may be detected as the corresponding points.

The outermost contour extraction unit 4 extracts the contour on the outermost side (outermost contour) of an object such as a figure included in each of the first image and the second image acquired by the acquisition unit 1, and gives information on each of the extracted outermost contours to the detection unit 5.

For example, the outermost contour extraction unit 4 performs contour extraction in each of the first image and the second image and, among the extracted contours, determines the contours that are not included inside the other contours as the outermost contours. As a contour extraction method, a typical edge detection technique can be utilized.

The detection unit 5 detects similar areas that are the areas similar to each other between the images from each of the first image and the second image based on the outermost contours extracted by the outermost contour extraction unit 4 from each of the first image and the second image and the number of corresponding points detected by the matching unit 3, and gives information on the detected similar areas to the output unit 6.

For example, the detection unit 5 counts the number of corresponding points included in each of the areas within each of the outermost contours extracted from the first image, and detects, as the similar area within the first image, the area having the largest number of corresponding points among the areas within each of the outermost contours extracted from the first image. Similarly, the detection unit 5 counts the number of corresponding points included in each of the areas within each of the outermost contours extracted from the second image, and detects, as the similar area within the second image, the area having the largest number of corresponding points among the areas within each of the outermost contours extracted from the second image. When the largest number of corresponding points does not reach the reference value, it may be determined as having no similar area. Furthermore, not the number of corresponding points included in the areas within the outermost contours but the number of corresponding points included in rectangular areas circumscribed to the outermost contours may be counted to detect the area having the largest number of corresponding points as the similar area.

The output unit 6 cuts out the image of the rectangular area circumscribed to the outermost contour in the area detected as the similar area by the detection unit 5 from each of the first image and the second image acquired by the acquisition unit 1, and outputs the cutout images as a similar image pair.

Note that the rectangular area circumscribed to the outermost contour of the similar area may not be directly cut out as it is from both of the first image and the second image. The rectangular area may be cut out by changing the size of the rectangle. For example, the rectangular area may be slightly increased by adding a margin in the outer periphery of the rectangle to be cut out at least for one of the first image and the second image. Inversely, the size of the rectangle may be slightly reduced to be cut out. The similar image pair output from the output unit 6 may be utilized as learning data that is used for training the feature extractor used for similar image search including a partial similarity described above, for example.

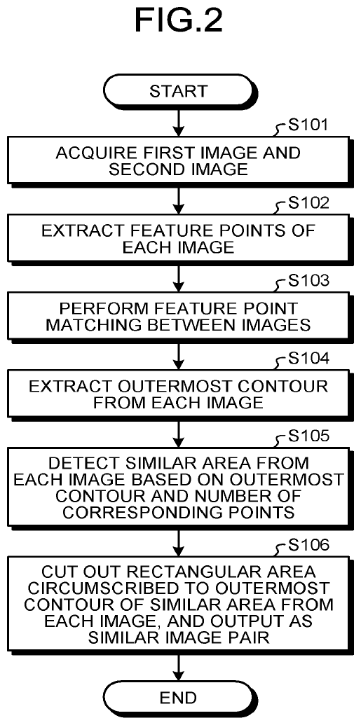

Next, a specific example of the processing performed by the similar area detection device according to the present embodiment will be described by referring to a specific case. FIG. 2 is a flowchart illustrating an example of a processing sequence of the similar area detection device according to the present embodiment.

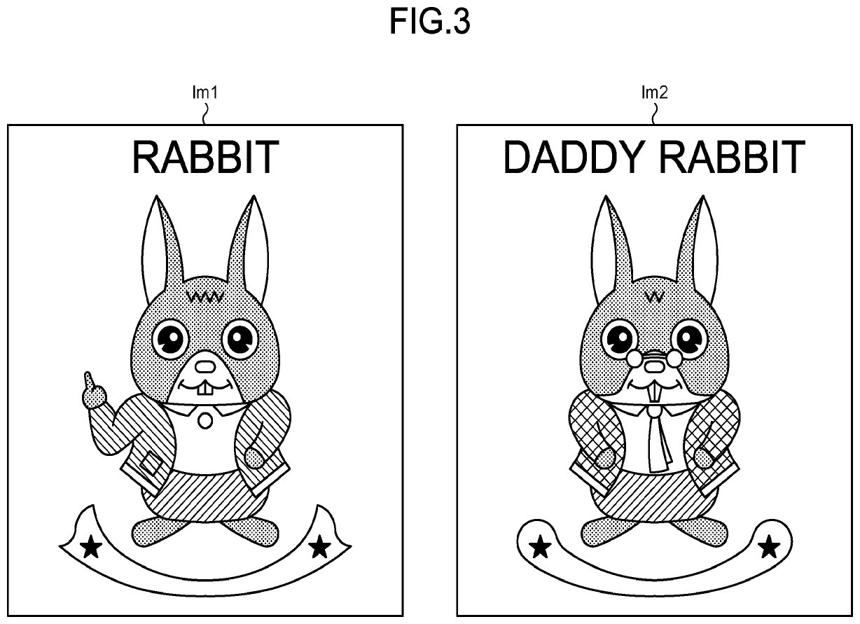

First, the acquisition unit 1 acquires a first image and a second image (step S101). Herein, it is assumed that a first image Im1 and a second image Im2 illustrated in FIG. 3 are acquired by the acquisition unit 1.

Then, the feature point extraction unit 2 extracts feature points in each of the first image and the second image acquired by the acquisition unit 1, and calculates the local features of each of the feature points (step S102). Then, the matching unit 3 performs feature point matching between the feature points of the first image and the feature points of the second image based on the closeness of the local feature of each of the feature points to detect the corresponding points of the first image and the second image (step S103).

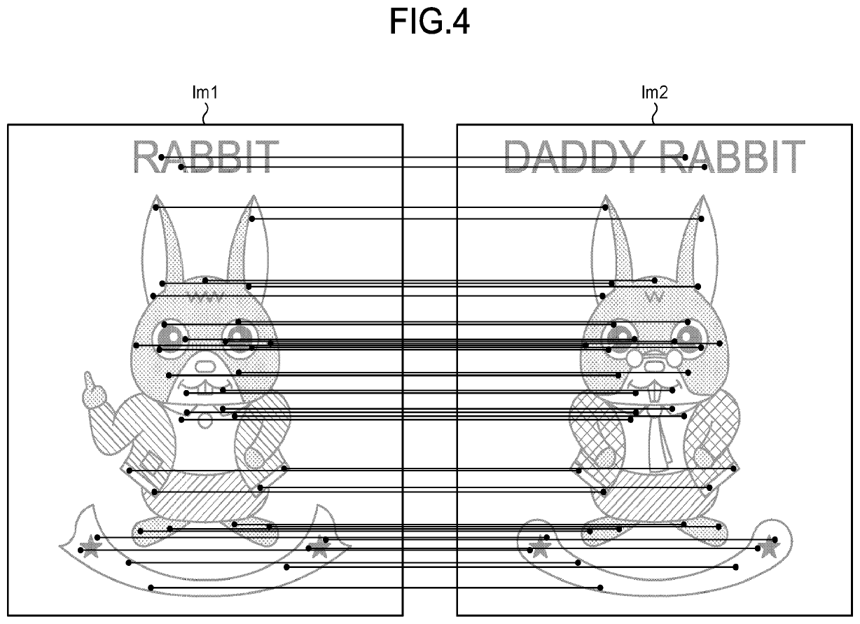

FIG. 4 illustrates examples of the corresponding points detected by the matching unit 3 from the first image Im1 and the second image Im2 illustrated in FIG. 3. Black circles at both ends connected by a straight line in the drawing indicates the corresponding points of the first image Im1 and the second image Im2. While only a small number of corresponding points are illustrated in a limited manner in FIG. 4 for simplification, it is general practice that a greater number of corresponding points are actually detected.

Then, the outermost contour extraction unit 4 extracts the outermost contours of objects included within the image from each of the first image and the second image acquired by the acquisition unit 1 (step S104).

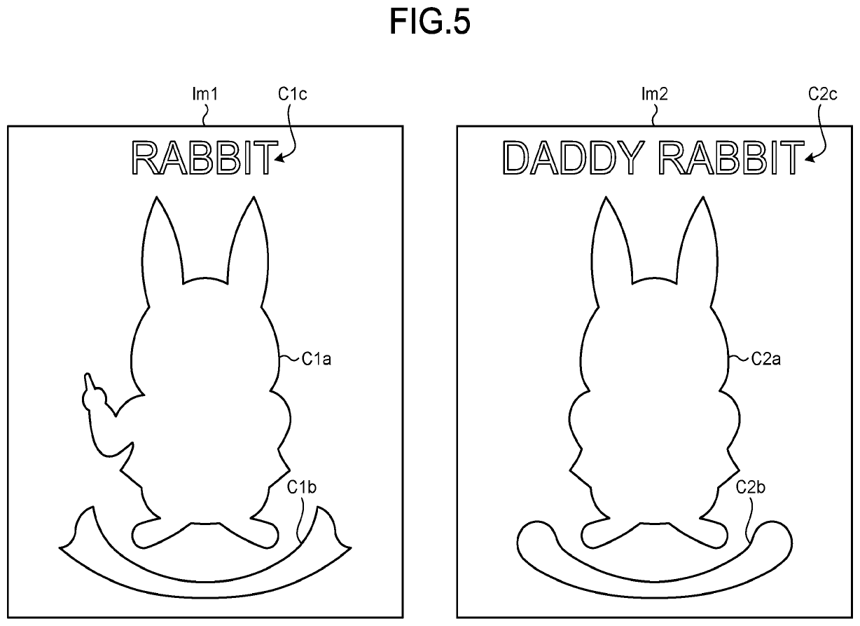

FIG. 5 illustrates examples of the outermost contours extracted by the outermost contour extraction unit 4 from the first image Im1 and the second image Im2 illustrated in FIG. 3. In the case of FIG. 5, outermost contours C1a, C1b of two figures are extracted from the first image Im1, and outermost contours C2a, C2b of two figures are extracted from the second image Im2. Furthermore, an outermost contour C1c of a character string is extracted from the first image Im1, and an outermost contour C2c of a character string is extracted from the second image Im2 as well. In a case where only the figures are taken as the determination target of similarity, whether the objects within the images are figures or characters may be determined so as not to extract the outermost contours C1c and C2c of the character strings. Furthermore, a configuration is usable that prevents extracting a small outermost contour whose size ratio with respect to the entire image is less than a prescribed value.

While it is described herein to perform outermost contour extraction at step S104 after performing feature point extraction at step S102 and feature point matching at step S103, feature point extraction and feature point matching may be performed after performing outermost contour extraction. Furthermore, feature point extraction, feature point matching, and outermost contour extraction may not be performed sequentially but may be performed in parallel.

Then, the detection unit 5 detects similar areas from each of the first image and the second image based on the outermost contours extracted by the outermost contour extraction unit 4 from each of the first image and the second image and the number of corresponding points detected by the matching unit 3 (step S105).

For example, the detection unit 5 counts the number of corresponding points detected in the area within each of the outermost contours for every outermost contour extracted from the first image, and detects the area having the largest number of corresponding points among the areas within each of the outermost contours as the similar area in the first image. Similarly, the detection unit 5 counts the number of corresponding points detected in the area within each of the outermost contours for every outermost contour extracted from the second image, and detects the area having the largest number of corresponding points among the areas inside each of the outermost contours as the similar area in the second image.

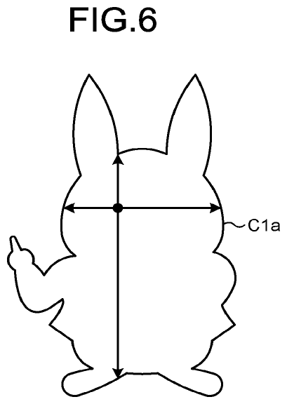

As a methodology for determining whether the corresponding point is on the inner side of the outermost contour, a method is usable that checks a plurality of directions such as top-and-bottom and left- and right directions from the corresponding point as illustrated in FIG. 6, for example, and determines that the corresponding point is on the inner side of the outermost contour when pixels belonging to the same outermost contour exist in all of the directions. When the corresponding point is on the outermost contour, the corresponding point may be counted as being inside the outermost contour or may not be counted as being outside the outermost contour.

Furthermore, as a methodology for determining whether the corresponding point is inside the outermost contour, a method is usable that allots common identification information to each pixel on the outermost contour and the inside area thereof for each of the outermost contours, and determines that the corresponding point exists on the inner side of the outermost contour indicated by the identification information when the identification information is allotted on the coordinate of the corresponding point. For example, a reference image in a same size as that of the first image and the second image, in which each pixel on the outermost contour and inside area thereof has a common pixel value other than 0 and pixel values of the pixels outside the outermost contour are 0, is formed for each of the outermost contours. In the reference image, when the pixel value of the pixel at the same coordinate with that of the corresponding point detected from the first image and the second image is other than 0, the corresponding point may be determined to exist on the inner side of the outermost contour corresponding to the pixel value indicated in the reference image.

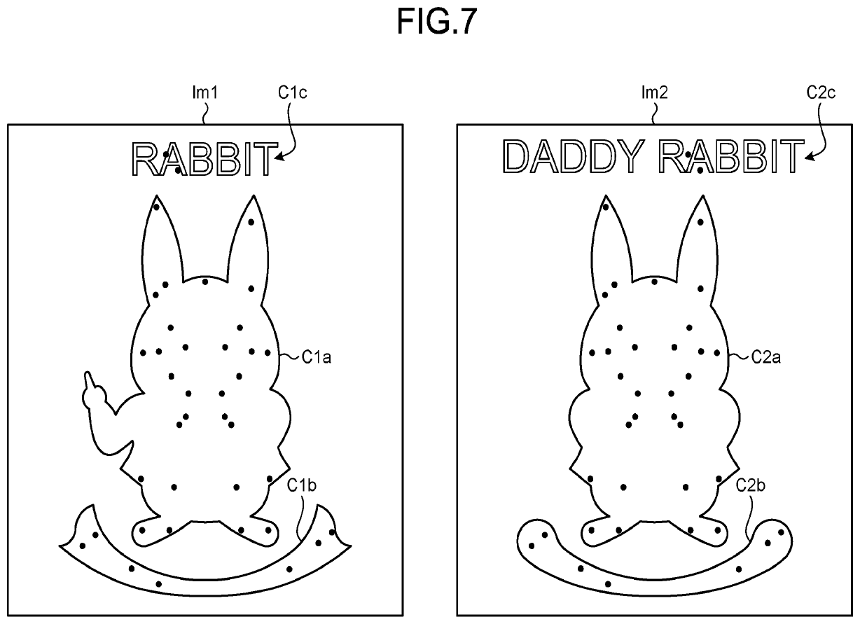

FIG. 7 illustrates examples of relations regarding the outermost contours C1a, C1b, C1c extracted from the first image Im1, the outermost contours C2a, C2b, C2c extracted from the second image Im2 illustrated in FIG. 3, and the corresponding points detected in each of the first image Im1 and the second image Im2. In the case illustrated in FIG. 7, among the outermost contours C1a, C1b, and C1c extracted from the first image Im1, the outermost contour having the largest number of corresponding points detected on the inner side thereof is the outermost contour C1a. Furthermore, among the outermost contours C2a, C2b, and C2c extracted from the second image Im2, the outermost contour having the largest number of corresponding points detected on the inner side thereof is the outermost contour C2a. Therefore, the detection unit 5 detects an area inside the outermost contour C1a (a partial area surrounded by the outermost contour C1a within the first image Im1) as a similar area in the first image Im1, and detects an area inside the outermost contour C2a (a partial area surrounded by the outermost contour C2a within the second image Im2) as a similar area in the second image Im2.

At last, the output unit 6 cuts out the rectangular area circumscribed to the outermost contour of the similar area detected by the detection unit 5 from each of the first image Im1 and the second image Im2 acquired by the acquisition unit 1, and outputs a combination of the image of the rectangular area cut out from the first image Im1 and the image of the rectangular area cut out from the second image Im2 as a similar image pair (step S106). Thereby, a series of processing executed by the similar area detection device according to the present embodiment is ended.

Note that the output unit 6 may not directly cut out the rectangular area circumscribed to the outermost contour of the similar area but may cut out the rectangular area by changing the size of the rectangle as described above and output a similar image pair. Furthermore, in a case where the sizes of the rectangles in two images configuring the similar image pair are different, the sizes of the rectangles in the two images may be aligned by adding a margin to the rectangle of the smaller size or by reducing the rectangle of the larger size.

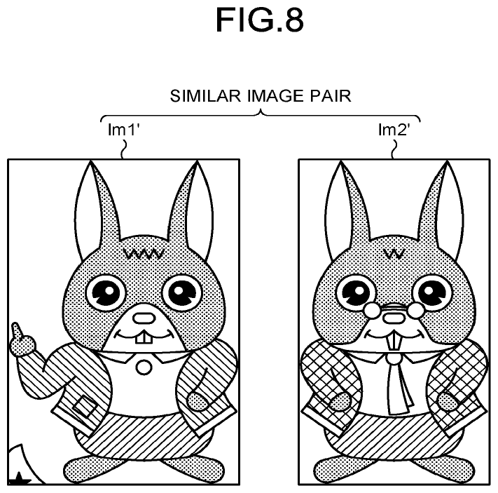

FIG. 8 illustrates an example of the similar image pair output from the output unit 6. FIG. 8 illustrates a case where a combination of an image Im1′ that is the cut-out rectangular area circumscribed to the outermost contour C1a of the first image Im1 illustrated in FIG. 3 and an image Im2′ that is the cut-out rectangular area circumscribed to the outermost contour C2a of the second image Im2 illustrated in FIG. 3 is output as the similar image pair. The similar image pair output by the output unit 6 can be utilized as the learning data for training the feature extractor to learn such that the features of the similar image pair become close as described above.

As has been described above in detail by referring to the specific case, the similar area detection device according to the present embodiment includes: the acquisition unit 1 that acquires the first image and the second image; the feature point extraction unit 2 that extracts the feature points from each of the first image and the second image; the matching unit 3 that associates the feature points extracted from the first image with the feature points extracted from the second image, and detects the corresponding points of the images; the outermost contour extraction unit 4 that extracts the outermost contours from each of the first image and the second image; and the detection unit 5 that detects, from each of the first image and the second image, the similar area that is a partial area similar to each other between the first image and the second image based on the outermost contours extracted by the outermost contour extraction unit 4 and the number of corresponding points detected by the matching unit 3. As such, the similar area detection device enables automatically detecting the similar area from each of the first image and the second image without necessitating, for example, teaching operations being performed manually.

The similar area detection device according to the present embodiment further includes the output unit 6 that cuts out the image of the rectangular area circumscribed to the outermost contour of the similar area detected by the detection unit 5 from each of the first image and the second image, and outputs as the similar image pair. Accordingly, with the use of the similar area detection device, the similar image pair used as the learning data for training the aforementioned feature extractor can be generated not manually but automatically, and the feature extractor can be efficiently trained.

### Second Embodiment

Next, a second embodiment will be described. The second embodiment is different from the above-described first embodiment in terms of the methodology for detecting the similar area from each of the first image Im1 and the second image Im2. Since the basic configuration and the outline of the processing of the similar area detection device are the same as those of the first embodiment, only the characteristic part of this embodiment will be described hereinafter while avoiding explanations duplicated with those of the first embodiment.

The detection unit 5 of the first embodiment detects, as the similar area for each of the first image and the second image, the area having the largest number of corresponding points among the areas within the outermost contour included in each of the images. In the meantime, the detection unit 5 of the second embodiment detects, as the similar area for each of the first image and the second image, the area having the number of corresponding points that exceeds a similarity determination threshold set in advance among the areas within the outermost contour.

The processing performed by the detection unit 5 according to the embodiment will be described in a specific manner by referring to the case illustrated in FIG. 7. In the case illustrated in FIG. 7, as for the outermost contours C1a, C1b, and C1c extracted from the first image Im1, thirty corresponding points are detected within the outermost contour C1a, seven corresponding points are detected within the outermost contour C1b, and one each of corresponding points is detected within the areas of two characters of the outermost contour C1c. Similarly, as for the outermost contours C2a, C2b, and C2c extracted from the second image Im2, thirty corresponding points are detected within the outermost contour C2a, seven corresponding points are detected within the outermost contour C2b, and one each of corresponding points is detected within the areas of two characters of the outermost contour C2c. Note here that when the similarity determination threshold is set as “5”, the detection unit 5 detects, as the similar areas in the first image Im1, the area within the outermost contour C1a and the area within the outermost contour C1b having the number of corresponding points detected inside thereof exceeding “5” that is the similarity determination threshold, among the outermost contours C1a, C1b, and C1c extracted from the first image Im1. Similarly, the detection unit 5 detects, as the similar areas in the second image Im2, the area within the outermost contour C2a and the area within the outermost contour C2b having the number of corresponding points detected inside thereof exceeding “5” that is the similarity determination threshold, among the outermost contours C2a, C2b, and C2c extracted from the second image Im2.

As described above, the detection unit 5 of the first embodiment is configured to detect the area within the outermost contour having the largest number of corresponding points as the similar area for each of the first image and the second image. As such, the detection unit 5 of the first embodiment cannot detect a plurality of similar areas from each of the first image and the second image. In contrast, the detection unit 5 of this embodiment detects the area within the outermost contour having the number of corresponding points that exceeds the similarity determination threshold as the similar area, so that the detection unit 5 of this embodiment can detect a plurality of similar areas from each of the first image and the second image.

In a case where a plurality of similar areas is detected from each of the first image and the second image, it is possible to specify the corresponding relations regarding which of the similar areas in the first image is similar to which of the similar areas in the second image by referring to the relations of the corresponding points within each of the similar areas. For example, in the case illustrated in FIG. 7, most of the corresponding points within the outermost contour C1a of the first image Im1 are associated with the corresponding points within the outermost contour C2a of the second image Im2, and most of the corresponding points within the outermost contour C1b of the first image Im1 are associated with the corresponding points within the outermost contour C2b of the second image Im2. Therefore, it can be found that the area within the outermost contour C1a and the area within the outermost contour C2a are in a corresponding relation, and that the area within the outermost contour C1b and the area within the outermost contour C2b are in a corresponding relation.

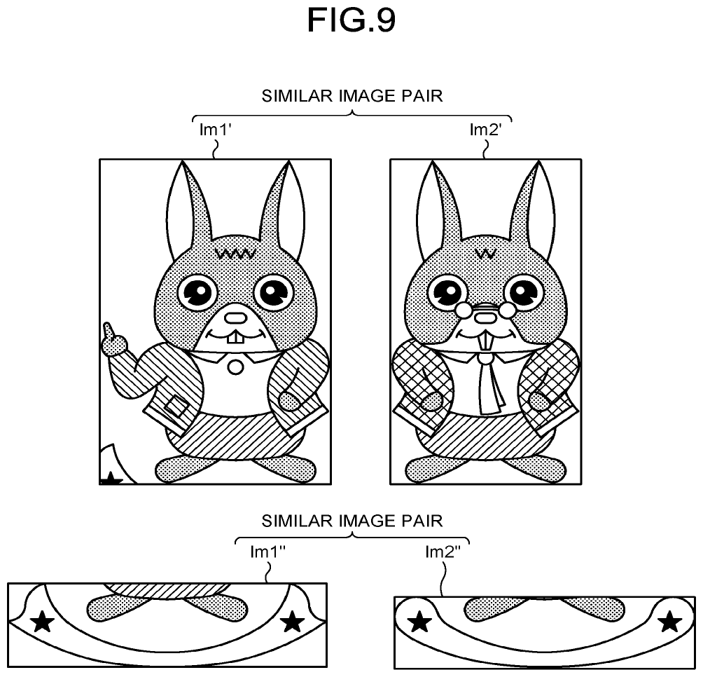

In the embodiment, when a plurality of similar areas is detected by the detection unit 5 from each of the first image and the second image, the output unit 6 outputs a plurality of similar image pairs. FIG. 9 illustrates examples of such similar image pairs output from the output unit 6 according to the embodiment. FIG. 9 illustrates the case where a combination of the image Im1′ that is a cut-out rectangular area circumscribed to the outermost contour C1a of the first image Im1 illustrated in FIG. 3 and the image Im2′ that is a cut-out rectangular area circumscribed to the outermost contour C2a of the second image Im2 illustrated in FIG. 3, and a combination of an image Im1″ that is a cut-out rectangular area circumscribed to the outermost contour C1b of the first image Im1 illustrated in FIG. 3 and an image Im2″ that is a cut-out rectangular area circumscribed to the outermost contour C2b of the second image Im2 illustrated in FIG. 3 are output, respectively, as the similar image pairs.

As described above, with the similar area detection device according to the present embodiment, the detection unit 5 detects, as the similar area for each of the first image and the second image, the area within the outermost contour having the number of corresponding points that exceeds the similarity determination threshold set in advance. Therefore, when the first image and the second image include a plurality of similar areas, it is possible with the similar area detection device to automatically detect such similar areas from each of the first image and the second image, and to automatically generate a plurality of similar image pairs.

### Third Embodiment

Next, a third embodiment will be described. With the third embodiment, when cutting out the image of the rectangular area circumscribed to the outermost contour of the similar area from each of the first image and the second image and outputting the cutout images as a similar image pair, the output unit 6 eliminates objects captured in a background area other than the similar area within the rectangular area (area outside the outermost contour that is the contour of the similar area). Since the basic configuration and the outline of the processing of the similar area detection device are the same as those of the first embodiment and the second embodiment, only the characteristic part of this embodiment will be described hereinafter while avoiding explanations duplicated with those of the first embodiment and the second embodiment.

The processing performed by the output unit 6 according to the embodiment will be described in a specific manner by referring to the case illustrated in FIG. 9. FIG. 9 illustrates two sets of similar image pairs output from the output unit 6 of the second embodiment. The image Im1′ as one of the rectangular areas configuring one of the similar image pairs is an image where a part of the object having the outermost contour C1b is captured in the background area outside the similar area (area within the outermost contour C1a). Furthermore, the image Im1″ as one of the rectangular areas configuring the other similar image pair is an image where a part of the object having the outermost contour C1a is captured in the background area outside the similar area (area within the outermost contour C1b), and the image Im2″ as the other rectangular area configuring the other similar image pair is an image where a part of the object having the outermost contour C2a is captured in the background area outside the similar area (area within the outermost contour C2b).

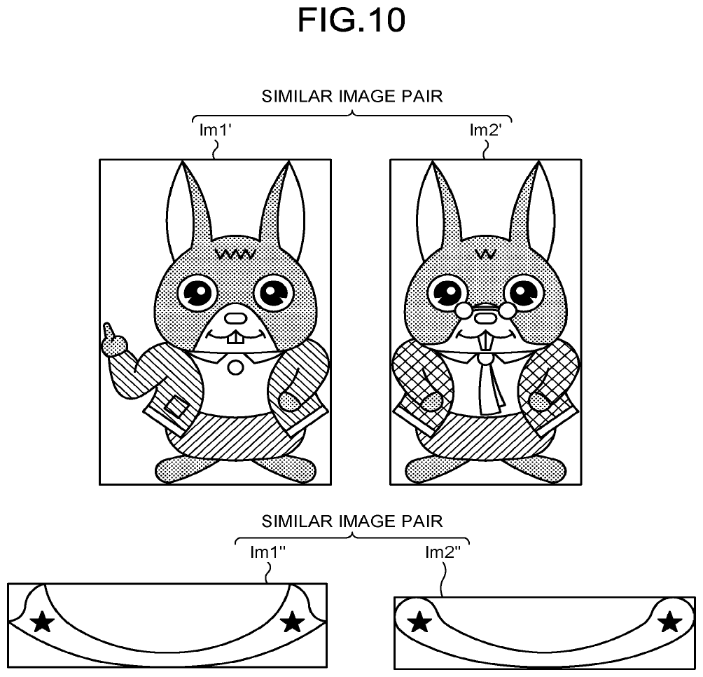

In such a case where the images of the rectangular areas in which another object is captured in the background thereof (the images Im1′, Im1″, Im2″″ illustrated in FIG. 9) are cut out from the first image and the second image, the output unit 6 according to the embodiment eliminates the object captured in the background of the images and outputs the cutout images as the images constituting a similar image pair. FIG. 10 illustrates examples of the similar image pairs output from the output unit 6 according to the embodiment. As illustrated in FIG. 10, in the embodiment, the object captured in the background area of each of the images configuring the similar image pair is eliminated.

As described above, with the similar area detection device according to the present embodiment, when cutting out the image of the rectangular area circumscribed to the outermost contour of the similar area from each of the first image and the second image and outputting the cutout images as a similar image pair, the output unit 6 eliminates the objects captured in the background area within the rectangular area. Therefore, with the use of the similar area detection device, automatic generation is possible for the similar image pair not including information other than the similar area as a noise.

### Fourth Embodiment

Next, a fourth embodiment will be described. In the fourth embodiment, in order to decrease misdetection of the similar areas performed by the detection unit 5, the detection unit 5 detects the similar area from each of the first image and the second image by using the positional relations of the corresponding points in addition to the outermost contours and the number of corresponding points in each of the first image and the second image. Since the basic configuration and the outline of the processing of the similar area detection device are the same as those of the first to third embodiments, only the characteristic part of this embodiment will be described hereinafter while avoiding explanations duplicated with those of the first to third embodiments.

The detection unit 5 according to the embodiment estimates the similar areas in the first image and the second image in the same manner as that of the first embodiment and the second embodiment described above, and then checks the positional relations of the corresponding points within each of the estimated similar areas to determine whether the estimated similar areas are correct. That is, as for the similar area in the first image and the similar area in the second image, the positional relations of the corresponding points detected on the inner side thereof are considered to be similar. Therefore, when the positional relations of the corresponding points are not similar, those areas are determined as not being similar areas. That is, among the similar areas estimated based on the outermost contours and the number of corresponding points in each of the first image and the second image, those having the similar positional relations of the corresponding points are detected as the similar area.

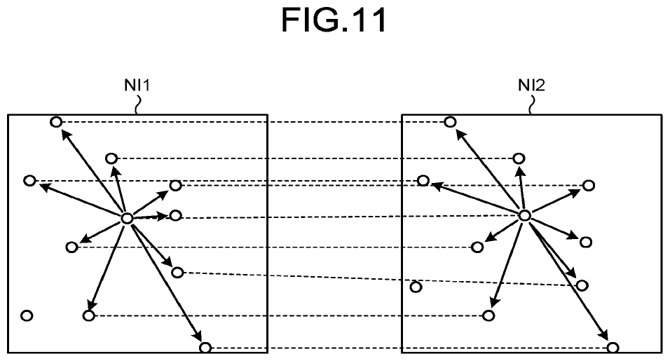

The processing performed by the detection unit 5 according to the embodiment will be described by referring to FIG. 11. The detection unit 5 according to the embodiment estimates the similar area in the first image and the similar area in the second image, and then performs normalization for comparing the positional relations of the corresponding points within each of the estimated similar areas. Specifically, normalization is performed such that the circumscribed rectangle of the similar area in the first image and the circumscribed rectangle of the similar area in the second image become squares of the same size, for example, so as to acquire normalized images NI1 and NI2 as illustrated in FIG. 11. Then, the detection unit 5 checks the positional relation of the corresponding points in each of the normalized images NI1 and NI2. When the positional relation of the corresponding points in the normalized image NI1 and the positional relation of the corresponding points in the normalized image NI2 are similar, the detection unit 5 determines that the estimated similar areas are correct. In the meantime, when the positional relation of the corresponding points in the normalized image NI1 and the positional relation of the corresponding points in the normalized image NI2 are not similar, it is determined that the estimated similar areas are not correct.

As a methodology for comparing the positional relations of the corresponding points, for example, coordinates of the corresponding points in the normalized images NI1 and N12 are used to calculate the distance between two corresponding points in each of the normalized images NI1 and N12. Then, when a difference between the calculated distance between the two corresponding points in the normalized image NI1 and the calculated distance between the two corresponding points in the normalized image N12 is within a threshold, it is determined that the positional relations between the two points match each other between the similar area estimated in the first image and the similar area estimated in the second image. Furthermore, when the ratio of the corresponding points determined to be in the matching positional relations with respect to the entire corresponding points within each of the estimated similar areas exceeds a prescribed value, for example, it is determined that the positional relation of the corresponding points within the estimated similar area in the first image and the positional relation of the corresponding points within the estimated similar area in the second image are similar.

Note that whether the positional relations of the two corresponding points match each other may not be determined based on the distance between the two corresponding points calculated by using the coordinates of the corresponding points in the normalized images NI1 and N12. For example, based on relative positions of the two corresponding points in one of the normalized images NI1 and N12, the positions of the two corresponding points in the other normalized image may be estimated, and whether the positional relations of the two corresponding points match each other may be determined based on whether the positions of the two corresponding points in the other normalized image match the estimated positions.

As described above, with the similar area detection device according to the present embodiment, the detection unit 5 detects the similar area from each of the first image and the second image by using the positional relations of the corresponding points in addition to using the outermost contours and the number of corresponding points in each of the first image and the second image. Therefore, with the similar area detection device, misdetection of the similar areas by the detection unit 5 can be decreased.

### Fifth Embodiment

Next, a fifth embodiment will be described. In the fifth embodiment, in a case where a plurality of feature points, having local features close to that of a feature point extracted from one of the first image and the second image, is extracted from the other image, the matching unit 3 associates the feature point extracted from one of the images with the feature points extracted from the other image. Since the basic configuration and the outline of the processing of the similar area detection device are the same as those of the first to fourth embodiments, only the characteristic part of this embodiment will be described hereinafter while avoiding explanations duplicated with those of the first to fourth embodiments.

In each of the embodiments described above, when performing feature point matching between the first image and the second image, the matching unit 3 associates the feature point in one of the images with the feature point in the other image having the closest local feature as that of the feature point in the one image. With such a method, however, in a case where a plurality of objects similar to an object included in one of the images is included in the other image, the corresponding points in the other image may be scattered in a plurality of areas so that the similar area in the other image cannot be detected properly.

In the meantime, with this embodiment, in a case where a plurality of feature points, having local features close to that of a feature point extracted from one of the first image and the second image, is extracted from the other image, the matching unit 3 performs feature point matching between the first image and the second image so as to associate the feature point extracted from one of the images with the feature points extracted from the other image. Therefore, in a case where a plurality of objects similar to an object included in one of the images is included in the other image, the corresponding points are not scattered in a plurality of areas in the other image. Thus, by detecting the similar areas from the other image using the same method as that of the second embodiment described above, for example, a plurality of similar areas is properly detectable from the other image. Furthermore, the embodiment enables generating and outputting a plurality of similar image pairs for the image of the rectangular area circumscribed to the outermost contour of the similar area detected from one of the images by combining with each of the images of a plurality of rectangular areas circumscribed to the outermost contours of the respective similar areas detected from the other image.

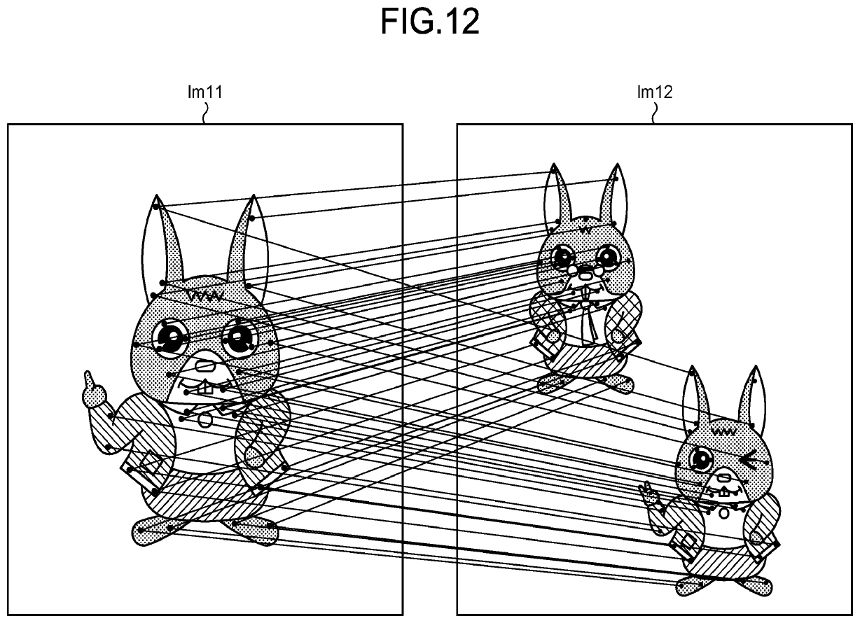

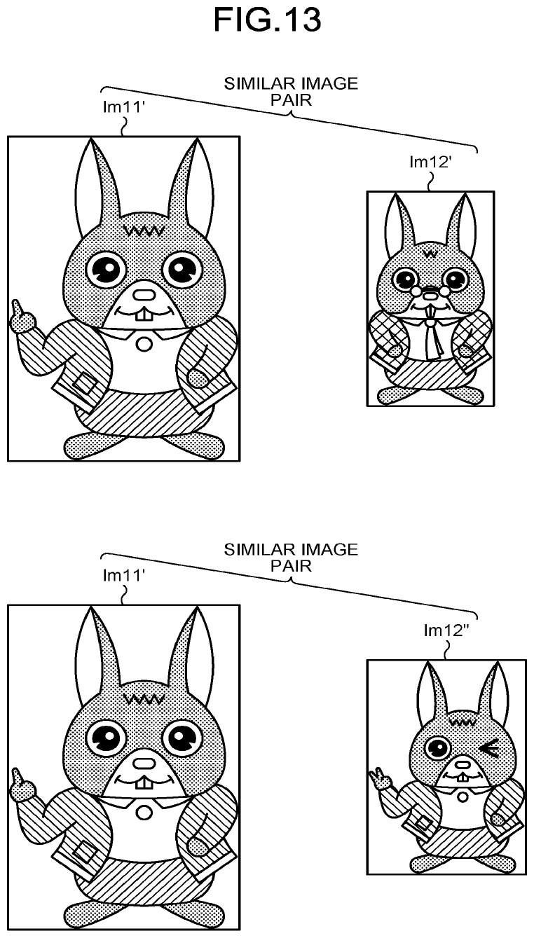

FIG. 12 illustrates an example of feature point matching performed by the matching unit 3 according to the embodiment, and FIG. 13 illustrates examples of the similar image pairs output from the output unit 6 according to the embodiment. In the case illustrated in FIG. 12, two feature points extracted from a second image Im12 are associated with a single feature point extracted from a first image Im11. Therefore, in the second image Im12, there are a large number of corresponding points existing in two areas within two outermost contours, and each of the two areas is detected as the similar area. As a result, as illustrated in FIG. 13, the output unit 6 outputs two similar image pairs that are: a combination of an image Im11′ of a rectangular area cut out from the first image Im11 and an image Im12′ of a rectangular area cut out from the second image Im12; and a combination of an image Im11′ of a rectangular area cut out from the first image Im11 and an image Im12″ of a rectangular area cut out from the second image Im12.

As described above, with the similar area detection device according to the present embodiment, in a case where a plurality of feature points, having local features close to that of a feature point extracted from one of the first image and the second image, is extracted from the other image, the matching unit 3 associates the feature point extracted from one of the images with the feature points extracted from the other image. Therefore, in a case where a plurality of objects similar to an object included in one of the images is included in the other image, with use of the similar area detection device, proper detection is possible for a plurality of similar areas from the other image by effectively preventing the corresponding points from being scattered in a plurality of areas in the other image.

Supplementary Notes

The similar area detection device of each of the embodiments described above can be implemented by using a general-purpose computer as basic hardware, for example. That is, functions of each of the units of the similar area detection device described above can be implemented by causing one or more hardware processors loaded on the general-purpose computer to execute a computer program. At this time, the computer program may be preinstalled on the computer, or the computer program recorded on a computer-readable storage medium or the computer program distributed via a network may be installed on the computer as appropriate.

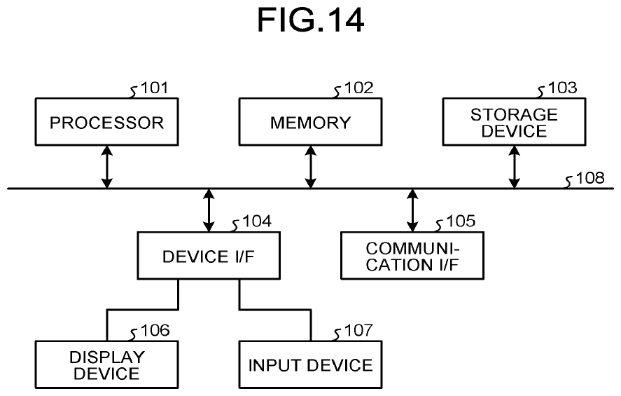

FIG. 14 is a block diagram illustrating a hardware configuration example of the similar area detection device according to each of the embodiments described above. As illustrated in FIG. 14, for example, the similar area detection device has the hardware configuration as a typical computer that includes: a processor 101 such as a central processing unit (CPU), a memory 102 such as a random access memory (RAM), a read only memory (ROM), or the like, a storage device 103 such as a hard disk drive (HDD), a solid state drive (SSD), or the like, a device I/F 104 for connecting devices like a display device 106 such as a liquid crystal panel, an input device 107 such as a keyboard, a pointing device, or the like, a communication I/F 105 for communicating with outside of the device, and a bus 108 that connects each of those units.

When implementing the similar area detection device of each of the embodiments described above with the hardware configuration illustrated in FIG. 14, the processor 101 may use the memory 102 to read out and execute the computer program stored in the storage device 103 or the like, for example, to implement the functions of each of the units such as the acquisition unit 1, the feature point extraction unit 2, the matching unit 3, the outermost contour extraction unit 4, the detection unit 5, and the output unit 6.

Note that a part of or a whole part of the functions of each of the units of the similar area detection device according to each of the embodiments described above may be implemented by dedicated hardware (not a general-purpose processor but a dedicated processor) such as an application specific integrated circuit (ASIC), a field-programmable gate array (FPGA), or the like. Furthermore, it is also possible to employ a configuration that implements the functions of each of the units described above by using a plurality of processors. Moreover, the similar area detection device of each of the embodiments described above is not limited to a case implemented by a single computer but may be implemented by distributing the functions to a plurality of computers.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A similar area detection device comprising:
one or more hardware processors configured to:
acquire a first image and a second image;
extract feature points from each of the first image and the second image;
associate the feature points extracted from the first image with the feature points extracted from the second image, and detect corresponding points between images;
extract an outermost contour from each of the first image and the second image; and
detect a similar area from each of the first image and the second image based on the outermost contour and a number of the corresponding points, the similar area being a partial area similar to each other between the first image and the second image.

2. The similar area detection device according to claim 1, wherein, among areas within the outermost contour included in each of the images, the one or more hardware processors detect an area having a largest number of the corresponding points as the similar area for each of the first image and the second image.

3. The similar area detection device according to claim 1, wherein, among areas within the outermost contour included in each of the images, the one or more hardware processors detect an area having the number of the corresponding points that exceeds a similarity determination threshold as the similar area for each of the first image and the second image.

4. The similar area detection device according to claim 1, wherein the one or more hardware processors are configured to cut out an image of a rectangular area circumscribed to the outermost contour of the similar area from each of the first image and the second image, and output cut-out images as a similar image pair.

5. The similar image detection device according to claim 4, wherein the one or more hardware processors eliminate an object captured in a background area other than the similar area within the rectangular area before outputting.

6. The similar area detection device according to claim 1, wherein the one or more hardware processors detect the similar area from each of the first image and the second image based on the outermost contour, the number of the corresponding points, and positional relations of the corresponding points.

7. The similar area detection device according to claim 1, wherein the one or more hardware processors associate, based on closeness of local features of feature points, the feature points extracted from the first image with the feature points extracted from the second image.

8. The similar area detection device according to claim 7, wherein,
in a case where a plurality of feature points, having local features close to a local feature of a feature point extracted from one image out of the first image and the second image, is extracted from other image, the one or more hardware processors associate the feature point extracted from the one image with the plurality of feature points extracted from the other image.

9. A similar area detection method executed by a similar area detection device, the similar area detection method comprising:
acquiring a first image and a second image;
extracting feature points from each of the first image and the second image;
matching by associating the feature points extracted from the first image with the feature points extracted from the second image and by detecting corresponding points between images;
extracting an outermost contour from each of the first image and the second image; and
detecting a similar area from each of the first image and the second image based on the outermost contour and a number of the corresponding points, the similar area being a partial area similar to each other between the first image and the second image.

10. A computer program product having a non-transitory computer readable medium including programmed instructions stored therein, wherein the instructions, when executed by a computer, cause the computer to perform:
acquiring a first image and a second image;
extracting feature points from each of the first image and the second image;
matching by associating the feature points extracted from the first image with the feature points extracted from the second image and by detecting corresponding points between images;
extracting an outermost contour from each of the first image and the second image; and
detecting a similar area from each of the first image and the second image based on the outermost contour and a number of corresponding points, the similar area being a partial area similar to each other between the first image and the second image.
